(19) United States
(12) Patent Application Publication
(10) Pub. No.: US 2021/0027318 A1
(43) Pub. Date: Jan. 28, 2021

(54) STORE MANAGEMENT DEVICE AND STORE MANAGEMENT METHOD

(71) Applicant: NEC Corporation, Tokyo (JP)

(72) Inventors: Shinya YAMASAKI, Tokyo (JP); Mizuto SEKINE, Tokyo (JP); Yoshinori EHARA, Tokyo (JP); Saika GOTO, Tokyo (JP); Yuka SUGANO, Tokyo (JP)

(73) Assignee: NEC Corporation, Tokyo (JP)

(21) Appl. No.: 16/981,638

(22) PCT Filed: Mar. 6, 2019
(86) PCT No.: PCT/JP2019/008808

§ 371 Date: Sep. 16, 2020

(30) Foreign Application Priority Data
Mar. 20, 2018 (JP) 2018-053215

(51) Int. Cl. G06Q 30/02

(52) U.S. Cl. CPC G06Q 30/0201

(57) ABSTRACT

A store management device is configured to generate a visitor table used to record information of a visitor who visits a store and to delete the information of the visitor who leaves the store from the visitor table after a predetermined process. For example, the predetermined process is a settlement of products purchased by the visitor. In addition, the visitor table is used to make a store-leaving approval when the visitor leaves the store.

### TECHNICAL FIELD

The present invention relates to a store management device and a store management method.

### BACKGROUND ART

A technology for managing customers via face authentication in stores has been known. In addition, a technology for automatically identifying products purchased by visitors in stores and for carrying out an automatic settlement has been developed. To achieve an automatic settlement of purchased products, it is necessary to automatically identify products, visitors taking products by hand, and conditions for visitors to carry products on register counters. That is, it is necessary to produce data tables configured to hold visitors' information and data tables configured to hold information of products carried by visitors on computers. Patent Document 1 discloses an information processing system using face authentication, which is configured to manage visitors' information on data tables. Specifically, Patent Document 1 discloses an operation to record visitor information representing an association between members' registration information and visitors' face information with a visitor database (paragraph [0060]) and an operation to delete visitors' information of customers who may leave stores from the visitor database (paragraph [0071]).

### CITATION LIST

### Patent Literature Document

Patent Document 1: Japanese Patent Application Publication No. 2016-126749

### SUMMARY OF INVENTION

### Technical Problem

The aforementioned visitor database configured to store the information relating to visitors may prove the existence of visitors in stores, wherein the visitors' information can be applied to automatic processing in management of stores. For example, the visitors' information can be used for product management and settlement of payment in stores. As described above, it is requested to develop an applied technology of visitors' information.

The present invention is made in consideration of the aforementioned circumstances, and therefore the present invention aims to provide a store management device and a store management method which can apply visitor information to automatic processing in management of stores.

### Solution to Problem

In a first aspect of the present invention, a store management device includes a visitor table generation part configured to generate a visitor table used to record the information of a visitor who visits a store, and a visitor table management part configured to delete the information of the visitor who leaves the store from the visitor table after a predetermined process.

In a second aspect of the present invention, a store management method includes the steps of: generating a visitor table used to record the information of a visitor who visits a store; and deleting the information of the visitor who leaves the store from the visitor table after a predetermined process.

In the above, for example, the predetermined process is a settlement of products purchased by the visitor. In addition, the visitor table is used to make a store-leaving approval when the visitor leaves the store.

### Advantageous Effects of Invention

According to the present invention, it is possible to apply the visitor information, which may prove the existence of visitors in stores, to automatic processing in management of stores.

### BRIEF DESCRIPTION OF DRAWINGS

FIG. 1 is an overview drawing of a store management system equipped with a store management device according to one embodiment of the present invention.

FIG. 2 is a perspective view showing the situation of aligning a plurality of product shelves in a store adopting the store management system.

FIG. 3 is a hardware configuration diagram of the store management device according to one embodiment of the present invention.

FIG. 4 is a functional block diagram of the store management device according to one embodiment of the present invention.

FIG. 5 is a flowchart of a visitor-table-generation process in a store management method according to one embodiment of the present invention.

FIG. 6 is a flowchart of a visitor-ID-identifying process in the store management method according to one embodiment of the present invention.

FIG. 7 is a flowchart of a first store management process in the store management method according to one embodiment of the present invention.

FIG. 8 is a flowchart of a second store management process in the store management method according to one embodiment of the present invention.

FIG. 9 is a flowchart of a third store management process in the store management method according to one embodiment of the present invention.

FIG. 10 is a flowchart of a fourth store management process in the store management method according to one embodiment of the present invention.

FIG. 11 is a flowchart of a fifth store management process in the store management method according to one embodiment of the present invention.

FIG. 12 is a block diagram showing a basic configuration of the store management device according to one embodiment of the present invention.

### DESCRIPTION OF EMBODIMENTS

A store management device and a store management method according to the present invention will be described with reference to the accompanying drawings. First, a store management device 1 according to one embodiment of the present invention will be described below.

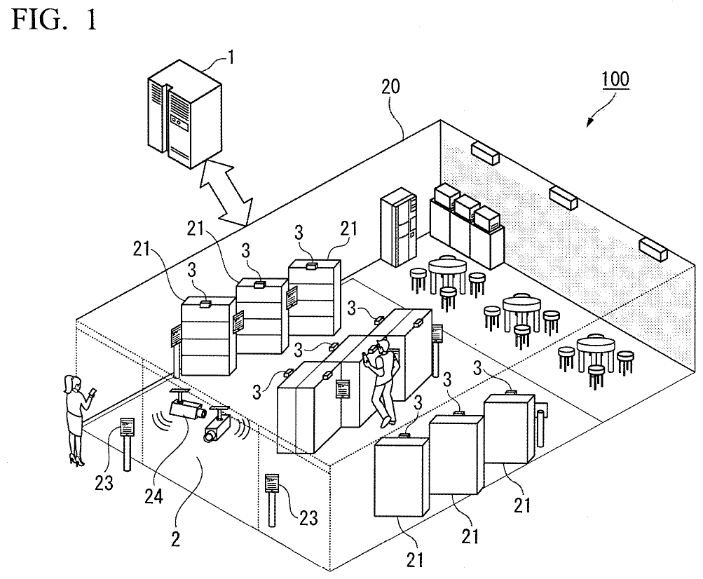

FIG. 1 is an overview drawing of a store management system 100 equipped with the store management device 1 according to one embodiment of the present invention. The store management device 1 is configured to communicate with various types of devices installed in a store 20. An entry/exit gate 2 is installed in an entrance/exit of the store 20. A plurality of product shelves 21 are installed in the store 20. Various types of products are displayed on the product shelf 21.

In the store management system 100, visitors may enter into or leave from the store 20 through the entry/exit gate 2. The entry/exit gate 2 is equipped with an entry/exit camera 24 configured to capture faces of visitors who may enter into the store 20 through the entry/exit gate 2, thus transmitting their facial images to the store management device 1. In this connection, the store 20 is equipped with a single entrance/exit gate 2, but it is possible to install an entrance gate and an exit gate at different positions in the store 20.

The store 20 is not necessarily limited to a manned store in which clerks are normally stationed, but the store 20 may be an unmanned store in which no clerks are stationed. The store 20 is furnished with a POS terminal which may be manually operated by a clerk to settle the payment of products a visitor may purchase and bring outside the store 20. Alternatively, it is possible to install a sensing device such as a camera in the store 20, which is used to automatically settle the payment of products a visitor may purchase and bring outside the store 20. Normally, when a visitor visits the store 20 by passing through the entry/exit gate 2, the visitor may touch a product displayed on the product shelf 21, may take the product from the product shelf 21 by hand, and may put the product into a cart, and then the visitor will leave the store 20 through the entry/exit gate 2. In a time period in which the visitor enters into the store 20 through the entry/exit gate 2 and then leaves the store 20, sensing devices such as an imaging device and a motion sensor installed in the store 20 may acquire the sensing information such as the feature information and the position information of a visitor as well as the identification information and the position information of a product taken by a visitor's hand, thus transmitting the sensing information to the store management device 1. Based on the sensing information, the store management device 1 may execute predetermined processes such as an automatic settlement of purchased products, a process for presenting a list of recommended products to a visitor, and a process for storing products put into a cart by a visitor.

Before executing the aforementioned predetermined processes, the store management device 1 needs to record the information relating to visitors (or visitor information) with a database. The visitor information may prove the existence of visitors in the store 20, and therefore the store management device 1 will carry out appropriate automatic processing for managing stores using the visitor information.

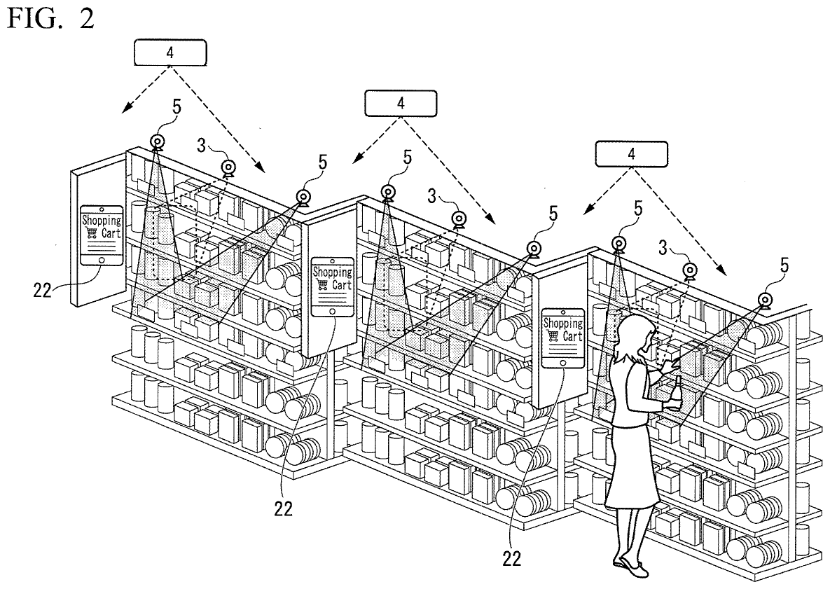

FIG. 2 is a perspective view showing the situation of aligning a plurality of product shelves 21 in the store 20, thus illustrating the state of a visitor who may select a product from the product shelf 21 and may take the product by hand. A first camera 3 configured to capture a facial image of a visitor is attached to the upper portion of the product shelf 21, however, it is possible to attach a plurality of first cameras 3 to the product shelf 21. In addition, a motion sensor 4 for sensing a motion of a visitor (or a customer) is located above the product shelf 21. Moreover, second cameras 5 configured to capture images of products taken by a visitor's hand or images of products returned to the product shelf 21 are attached to the upper portion of the product shelf 21. In this connection, it is not necessary to install the first camera 3 and the second cameras 5 in the product shelf 21, and therefore those cameras can be located in other places such as the ceiling or the floor of the store 20. That is, the first camera 3 should be installed at a position to capture a facial image of a visitor while the second camera 5 should be installed at a position to capture an image of a product taken by a visitor's hand or an image of a product returned to the product shelf 21. A store-installed terminal device 22 is attached to the product shelf 21.

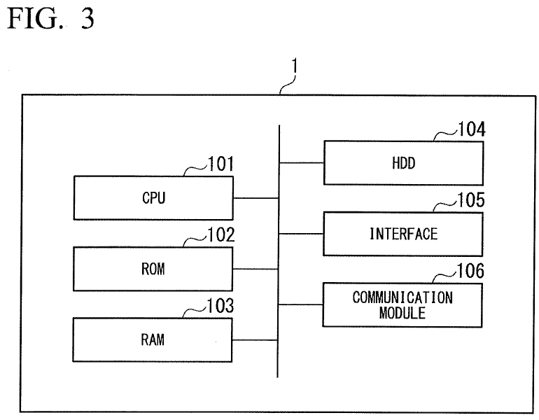

FIG. 3 is a hardware configuration diagram of the store management device 1. The store management device 1 includes a CPU (Central Processing Unit) 101, a ROM (Read-Only Memory) 102, a RAM (Random-Access Memory) 103, an HDD (Hard Disk Drive) 104, an interface 105, and a communication module 106. In this connection, the HDD 104 may be replaced with an SDD (Solid State Drive).

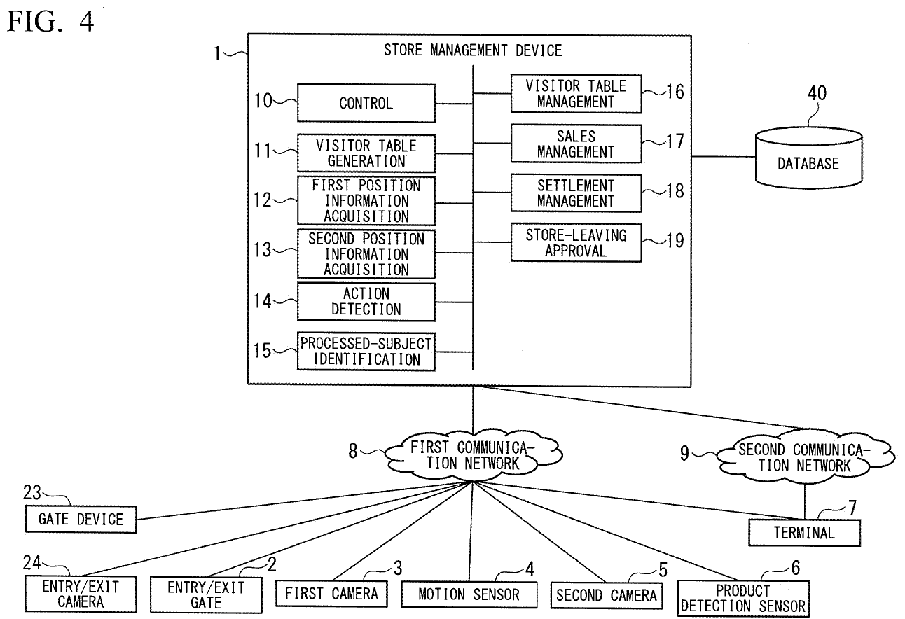

FIG. 4 is a functional block diagram of the store management device 1. The CPU 101 of the store management device 1 reads and executes a store management program which is stored on the ROM 102 or the HDD 104 in advance, thus realizing functional parts shown in FIG. 4. That is, the store management device 1 includes a control part 10, a visitor table generation part 11, a first position information acquisition part 12, a second position information acquisition part 13, an action detection part 14, a processed-subject identification part 15, a visitor table management part 16, a sales management part 17, a settlement management part 18, and a store-leaving-approval part 19.

The store management device 1 is connected to a database 40. In addition, the store management device 1 may communicate with various devices installed in the store 20 through a first communication network 8. Specifically, the store management device 1 is configured to communicate with the entry/exit gate 2, the first camera 3, the motion sensor 4, the second camera 5, a product detection sensor 6, a gate device 23, and the entry/exit camera 24. For example, the first communication network 8 is a dedicated network configured to interconnect the store management device 1 and various devices installed in the store 20. The store management device 1 may communicate with a terminal 7 held by a visitor through a second communication network 9. For example, the second communication network 9 may be configured of a mobile phone network, a wireless communication network, or the Internet. In this connection, the terminal 7 may communicate with the first communication network 8 instead of the second communication network 9 when a visitor enters into the store 20.

In the store management device 1, the control part 10 is configured to control the other functional parts 11 through 19. The visitor table generation part 11 is configured to generate a visitor table used to permit a visitor to leave the store 20 by storing the visitor information. For example, the visitor information may be a facial feature quantity of a visitor, a visitor ID, or an address of the terminal 7 held by the visitor. The first position information acquisition part 12 is configured to acquire the first position information representing the position of biological feature information of a visitor approaching products displayed on the product shelf 21 based on a visitor's facial image captured by the first camera 3. The first camera 3 is used to detect the biological feature information of a person reflected in an imaging scope thereof. For example, the first camera 3 is mounted on the product shelf 21 and thereby captures a face of a person positioned in the foreside of the product shelf 21. For example, the biological feature information may be person's facial feature information or feature information of irises of person's eyes. In this connection, the first position information acquisition part 12 may acquire the first position information representing the position of the visitor's biological feature information based on the visitor's facial image acquired from the entry/exit camera 24.

Based on the sensing information acquired from the motion sensor 4, the second position information acquisition part 13 is configured to acquire the second position information representing the position of a subject person who may extend an arm to reach a product by hand among persons approaching the product shelf 21. For example, the motion sensor 4 is attached to the ceiling of the store 20 above the product shelf 21 so as to detect a subject person thereunder in view of the ceiling of the store 20.

The action detection part 14 is configured to detect a visitor's action such as an action to move a product. For example, the action detection part 14 may detect an action to move a product based on an image from the second camera 5 configured to capture an image of a product displayed on the product shelf 21 and the detected information of the product detection sensor 6 configured to detect a product. The moving action of a product may be an action of a visitor to take a product by hand, an action to return a product to the product shelf 21, an action of a visitor to touch a product, an action of a visitor to put a product into a cart, or the like. In addition, the action detection part 14 is configured to detect whether a product is delivered to a visitor in the store 20. Moreover, the action detection part 14 is configured to track the position of a visitor who may move in the store 20.

Based on the position of a product and a product ID subjected to a moving action as well as the positional relationship between the first position information and the second position information, the processed-subject identification part 15 may identify the biological feature information of a subject person conducting the moving action on a product, thus reading a person ID associated with the biological feature information from the visitor table.

After a completion of settling payment of visitor's purchased products, the visitor table management part 16 may delete the visitor information from the visitor table or update the visitor information on the visitor table. The sales management part 17 is configured to generate a sales management table configured to store the information of a product (or product information) a visitor may take and bring by hand.

The settlement management part 18 is configured to settle the payment of visitor's purchased products and to determine whether to complete a settlement. When the visitor information has been described in the visitor table while the product information of visitor's purchased products unsettled in payment has been stored on the sales management table, for example, the settlement management part 18 may transmit to a device located proximate to a visitor (e.g. the visitor's terminal 7) a message urging the visitor to settle the payment of purchased products. The store-leaving-approval part 19 may output a store-leaving approval to a predetermined device when the visitor information relating to a visitor who may leave the store 20 is deleted from the visitor table. In addition, the store-leaving-approval part 19 may output a store-leaving approval to a predetermined device when the product information relating to visitor's purchased products unsettled in payment is no longer stored on the sales management table.

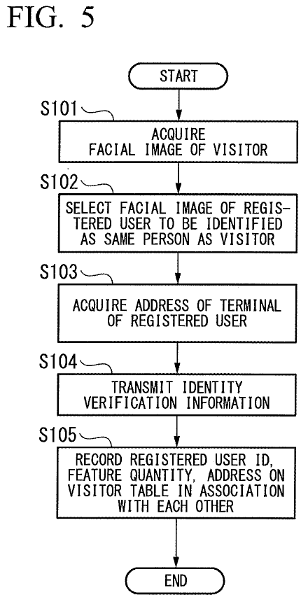

Next, a store management method according to one embodiment of the present invention will be described with reference to FIG. 5 through FIG. 11.

FIG. 5 is a flowchart of a visitor-table-generation process (steps S101 through S105). First, the visitor-table-generation part 11 acquires a visitor's facial image from the entry/exit camera 24 (S101). The visitor-table-generation part 11 is configured to compare a feature quantity of a facial image of a visitor with feature quantities of facial images of numerous customers (hereinafter, referred to as registered users) which are stored in the database 40 in advance, thus selecting from the database 40 a feature quantity of a registered user who can be identified as the same person as the visitor when a difference of feature quantity between the visitor and the registered user falls within an allowable range (S102). The visitor-table-generation part 11 reads a registered user ID associated with the feature quantity of the registered user from the database 40 so as to acquire the address of the terminal 7 of the registered user which is recorded on the database 40 in association with the registered user ID (S103). The visitor-table-generation part 11 transmits the identity verification information to the visitor's terminal 7 (S104). The visitor-table-generation part 11 records the address of the visitor's terminal 7 on the visitor table in association with the registered user ID and the feature quantity of the visitor's facial image (S105). Accordingly, it is possible to generate the visitor table with respect to the visitor who may enter into the store 20.

In this connection, the visitor-table-generation part 11 may generate the visitor table by executing the aforementioned steps S101 through S105 based on a visitor's facial image acquired from the first camera 3 installed in the store 20 instead of a visitor's facial image acquired from the entry/exit camera 24.

The aforementioned visitor table may be used for the store management device 1 to detect a moving action of a product. Specifically, the store management device 1 may identify a visitor who may take a product from the product shelf 21 by hand using the recorded information of the visitor table, thus identifying the visitor bringing the product while walking in the store 20. In addition, the visitor table can be used for other processes of the store management device 1. For example, it is possible to identify a visitor who may settle the payment of purchased products using the recorded information of the visitor table, thus identifying the visitor who may leave the store 20.

In the aforementioned visitor-identifying process, the first camera 3 is configured to capture an image of a person such as a visitor positioned in the foreside of the product shelf 21 in view of the product shelf 21, thus transmitting a still image or a moving image captured by the first camera 3 to the store management device 1. In addition, the motion sensor 4 is configured to sense a visitor thereunder in view of the ceiling of the store 20 above the product shelf 21, thus transmitting the sensing information to the store management device 1. For example, the sensing information of the motion sensor 4 may be a distant image which is produced by converting a distance to the position of an object obtained by infrared rays into an image. The product detection sensor 6 is installed for each of products displayed on the product shelf 21. Specifically, the product detection sensor 6 has a sheet-like shape laid beneath each product, wherein the product detection sensor 6 may be a pressure sensor configured to detect pressure due to a product's weight or a weight sensor configured to detect a product's weight. When a visitor takes a product from the product shelf 21 by hand, the product detection sensor 6 may transmit to the store management device a product-acquisition signal including its sensor ID and coordinates applied to the product on the product shelf 21 in the store 20.

The processed-subject identification part 15 is configured to identify a visitor ID from the visitor table based on an association of a timing of detecting coordinates representing the position of the feature information and the skeleton information of a person acquired from the first camera 3, the motion sensor 4, and the second camera 5 as well as an association of a timing of detecting coordinates of a product and its product ID which is stored in association with the sensor ID of the product detection sensor 6. As described above, the processed-subject identification part 15 is able to identify a processed-subject person.

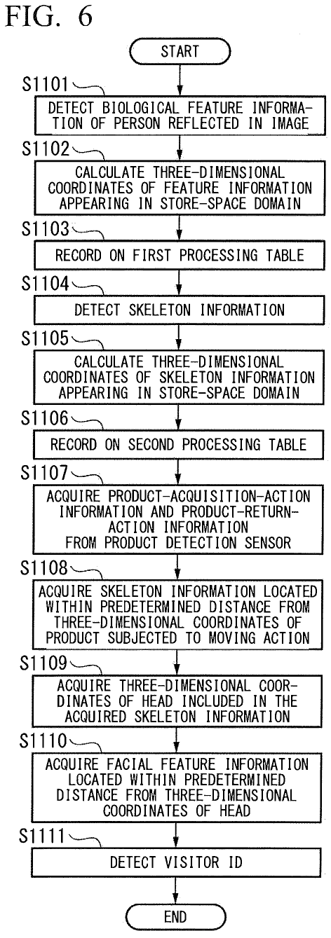

Next, a process for identifying a visitor ID of a visitor who may take a product from the product shelf 21 by hand will be described below. FIG. 6 is a flowchart of a visitor-ID-specifying process (steps S1101 through S1111).

The first position information acquisition part 12 is configured to capture several images to several tens of images in each second from a plurality of first cameras 3 which are installed to capture images of visitors positioned in the foreside of the product shelf 21. The first position information acquisition part 12 is configured to detect the biological feature information of a visitor reflected in images acquired from the first camera 3 (S1101). The biological feature information may be a person's facial feature information or feature information of irises of a person's eyes. Upon acquiring the biological feature information from images, the first position information acquisition part 12 may calculate spatial coordinates for acquiring the biological feature information. Upon determining a three-dimensional-imaging-space domain based on a viewing angle or an imaging direction in advance, for example, the first position information acquisition part 12 may acquire the three-dimensional-imaging-space domain of the first camera 3 from the database 40 so as to calculate three-dimensional coordinates in the three-dimensional-imaging-space domain in which the biological feature information may appear according to predetermined equations based on the three-dimensional-imaging-space domain, coordinates of the biological feature information which may appear in images, and the magnitude of the biological feature information. In addition, the first position information acquisition part 12 may calculate three-dimensional coordinates of the biological feature information which may appear in a store-space domain using conversion formulae used for conversion from three-dimensional coordinates in the three-dimensional-imaging-space domain of the first camera 3 into three-dimensional coordinates in the store-space domain (S1102). Upon successfully acquiring the biological feature information from images, the first position information acquisition part 12 may record three-dimensional coordinates of the biological feature information which may appear in the store-space domain on a first processing table in association with a camera ID of the first camera transmitting images, its detection time, and the biological feature information (S1103).

The second position information acquisition part 13 is configured to acquire several to several tens of distance images in each second from a plurality of motion sensors 4 which are attached to the ceiling of the store 20 above the product shelves 21 and configured to capture images of visitors positioned thereunder from their upper portions when visitors are located in the foreside of the product shelf 21. The second position information acquisition part 13 may analyze visitor's images reflected in distance images captured by motion sensors 4 so as to detect the skeleton information representing the position of a visitor's head in images and an axis of a visitor's arm extended toward a desired product (S1104). For example, the skeleton information includes coordinates or a vector representing the linear portion of a visitor's arm, which is produced by analyzing distance images, and coordinates of a distal end of a visitor's hand. In this connection, the skeleton information may include at least coordinates or vectors for determining positions of a visitor's head, arms, and distal ends of hands when viewing the visitor from the above as well as equations representing visitor's arm axes. Upon successfully acquiring the skeleton information representing visitor's arm axes and distal ends of hands from the aforementioned distance images, the second position information acquisition part 13 may calculate spatial coordinates of visitor's arms and distal ends of hands from the skeleton information. Similar to the first position information acquisition part 12, the second position information acquisition part 13 has stored a three-dimensional-imaging-space domain based on a viewing angle and an imaging angle in advance. The second position information acquisition part 13 is configured to acquire from the database 40 a three-dimensional-imaging-space domain of the motion sensor 4 so as to calculate three-dimensional coordinates of the skeleton information which may appear in the three-dimensional-imaging-space domain according to predetermined equations based on the three-dimensional-space-imaging domain, coordinates of the skeleton information which may appear in images, the distance from the motion sensor, and the like. In addition, the second position information acquisition part 13 is configured to calculate three-dimensional coordinates of the skeleton information which may appear in the store-space domain using conversion formulae used for conversion from three-dimensional coordinates in the three-dimensional-imaging-space domain to three-dimensional coordinates in the store-space domain (S1105). Upon successfully acquiring the skeleton information from images, the second position information acquisition part 13 may store three-dimensional coordinates of the skeleton information which may appear in the store-space domain on a second processing table in association with a sensor ID of the motion sensor 4 transmitting images, its detection time, and the skeleton information (S1106).

For example, the product detection sensor 6 is configured to detect a weight of a product or pressure due to the weight of the product and to transmit to the store management device 1 the predetermined information responsive to increase/decrease of pressure or the product's weight. When a decrease of pressure or the product's weight is above a threshold value, the product detection sensor 6 may transmit to the store management device 1 the product-acquire-action information including a flag indicating a decrease, a sensor ID, the displayed position of a product, and a detection time to detect a product-acquire action. When an increase of pressure or the product's weight is above a threshold value, the product detection sensor 6 may transmit to the store management device 1 the product-return-action information including a flag indicating an increase, a sensor ID, the displayed position of a product, and a detection time to detect a product-return action. Thereafter, the action detection part 14 acquires the product-acquire-action information and/or the product-return-action information from the product detection sensor 6 (S1107). Upon acquiring the product ID which is recorded in association with the sensor ID included in the product-acquire-action information, the action detection part 14 may detect that a product identified by the product ID has been taken from the product shelf 21. Upon acquiring the product ID which is recorded in association with the sensor ID included in the product-return-action information, the action detection part 14 may detect that a product identified by the product ID has been returned to the product shelf 21. The action detection part 14 is configured to send the product ID, which relates to the sensor ID included in the product-acquire-action information or the product-return-action information, the displayed position of the product, and the action-detection time to the processed-subject identification part 15.

Upon acquiring the product ID of a product subjected to a moving action, the displayed position of a product, and the action-detection time from the action detection part 14, the processed-subject identification part 15 determines whether the second processing table has stored the skeleton information which includes coordinates falling within a predetermined distance from three-dimensional coordinates corresponding to the displayed position of the product in the store-space domain within and which is associated with a detection time falling within a predetermined time difference from the action-detection time. The processed-subject identification part 15 acquires the skeleton information when the second processing table has stored the skeleton information which includes coordinates falling within the predetermined distance from three-dimensional coordinates of the product subject to the moving action and which is associated with the detection time falling within the predetermined time difference from the action-detection time (S1108). For example, the skeleton information may include three-dimensional coordinates of a distal end of a visitor's hand. When three-dimensional coordinates of a distal end of a visitor's hand approaches three-dimensional coordinates of a product substantially at the same time, the processed-subject identification part 15 may estimate the skeleton information including three-dimensional coordinates of a distal end of a visitor's hand as the skeleton information of a visitor who may take the product by hand. Therefore, the processed-subject identification part 15 acquires the detection time of detecting the skeleton information and three-dimensional coordinates of a visitor's head included in the skeleton information which is acquired based on three-dimensional coordinates of the product subject to a moving action (S1109). The processed-subject identification part 15 acquires from the first processing table the visitor's facial feature information whose detection time may fall within a predetermined time difference and which is associated with three-dimensional coordinates falling within a predetermined distance from three-dimensional coordinates of a visitor's head (S1110). The processed-subject identification part 15 may realize one aspect of processes for determining the position (i.e. the second position information) indicated by the skeleton information of a visitor who may extend an arm to reach a product by hand based on the position of the product subjected to a moving action and for detecting the position (i.e. the first position information) emerging the visitor's facial feature information having a significant positional information based on the position indicated by the skeleton information. When the store management device 1 has stored an association between the visitor's facial feature information and the visitor ID on the visitor table in the database 40 in advance, the processed-subject identification part 15 may detect the visitor ID using the visitor's facial feature information obtained from the skeleton information with reference to the visitor table (S1111). As described above, the store management device 1 is configured to determine the visitor ID from the visitor's biological feature information and the skeleton information based on the aforementioned information acquired from sensing devices.

The sales management part 17 is configured to update the sales management information which is recorded on the data table of the database 40 in association with the visitor ID and the product ID identified from an image captured by the second camera 5. The sales management part 17 may display a sales management table on a display device arranged in proximity to a visitor. Accordingly, it is possible for a visitor to confirm a list of products the visitor may take from the product shelf 21 by hand and put it into a cart.

When a visitor returns a product to the product shelf 21, the product detection sensor 6 may transmit to the store management device 1 the product-return-action information including the sensor ID and the position information such as coordinates of the product on the product shelf 21 in the store 20. Based on the position information of the product and its product ID stored in association with the sensor ID of the product detection sensor 6 indicated by the product-return-action information as well as the person's feature information and skeleton information, the sales management part 17 will release an association between the visitor ID and the product ID recorded on the sales management table. In this connection, the processed-subject identification part 15 may determine the visitor ID on the visitor table irrespective of releasing an association of the visitor ID and the product ID.

The action detection part 14 may detect a product ID of a product which a visitor may take from the product shelf 21 by hand and coordinates of the product on the product shelf 21 in the store 20 based on an image obtained from the second camera 5 instead of the sensing information of the product detection sensor 6. In addition, the action detection part 14 may detect a product ID of a product which a visitor may return to the product shelf 21 and coordinates of the product on the product shelf 21 in the store 20 based on an image obtained from the second camera 5. That is, the action detection part 14 needs to detect a visitor's moving action of a product based on at least one of the sensing information of the product detection sensor 6 and images of the second camera(s) 5.

According to the aforementioned processes, it is possible for the sales management part 17 to store the information as to which product a visitor may take from the product shelf 21 by hand and which product a visitor may return to the product shelf 21. In addition, the entry/exit camera 24 may capture a facial image of a visitor who may leave the store 20 through the entry/exit gate 2, and therefore the visitor table generation part 11 may delete from the visitor table a visitor ID which is determined based on a feature quantity of a visitor's facial image. The sales management part 17 is configured to carry out an automatic settlement using the visitor ID, the product ID, and the credit card number for settling the payment of visitor's purchased products, all of which are recorded on the database 40.

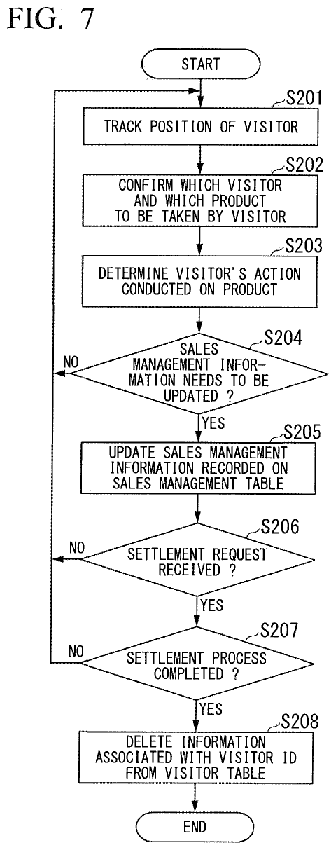

Next, a plurality of store management processes to be executed by the store management device 1 will be described with reference to FIG. 1 through FIG. 11. FIG. 7 is a flowchart of a first store management process (steps S201 through S208). As described above, the store management device 1 will carry out the first store management process after the visitor table generation part 11 generates the visitor table. First, the action detection part 14 may track a visitor upon detecting the position of a visitor based on the first position information. Specifically, when a visitor walks around the store 20 and stops in the foreside of a predetermined product shelf 21 to take a desired product by hand, the first position information acquisition part 12 determines the first position information representing three-dimensional coordinates of a facial feature quantity of a person approaching the product in the store-space domain based on an image obtained from the first camera 3. The action detection part 14 may record three-dimensional coordinates of the visitor in the store-space domain on the visitor table in association with the feature quantity of the visitor's facial image. In this connection, a process for recording three-dimensional coordinates of a visitor in the store-space domain will be repeatedly carried out based on images captured by the first cameras 3 located at multiple positions in the store 20. Accordingly, the action detection part 14 is able to track a visitor who may move in the store 20 (S201).

The second position information acquisition part 13 is configured to detect the second position information representing three-dimensional coordinates of a distal end of a hand of a visitor who may extend an arm to reach a product by hand within persons approaching products on the product shelf 21 based on the sensing information of the motion sensor 4. Subsequently, the action detection part 14 is configured to detect the product position information representing three-dimensional coordinates of a product located at a distal end of a visitor's hand based on the movement information representing a moving action of a product detected by the product detection sensor 6 and coordinates of the product on the product shelf 21 in the store 20. The action detection part 14 may recognize which visitor and which product taken by the visitor based on the relationship between the first position information, the second position information and the product position information (S202). The action detection part 14 sends to the processed-subject identification part the product-acquire-action information indicating that a visitor has conducted an action of taking a product on the product shelf 21 by hand. The processed-subject identification part 15 identifies the visitor who has taken the product by hand based on the product-acquire-action information, the first position information, the second position information, and the product position information, thus reading a visitor ID from the visitor table. The processed-subject identification part 15 sends the visitor ID and the product-acquire-action information to the sales management part 17. When the movement information of a product based on the sensing information of the product detection sensor 6 indicates that the visitor returned the product to the product shelf 21, the action detection part 14 sends the product-return-action information to the processed-subject identification part 15. The processed-subject identification part 15 identifies the visitor conducting a product-return action based on the product-return-action information, the first position information, the second position information, and the product position information, thus reading a visitor ID from the visitor table. The processed-subject identification part 15 sends the visitor ID and the product-return-action information to the sales management part 17.

Based on the action information obtained from the processed-subject identification part 15 (i.e. the product-acquire-action information or the product-return-action information), the sales management part 17 determines an action of a visitor conducted on a product on the product shelf 21 (S203). When the action information obtained from the processed-subject identification part 15 represents the product-acquire-action information, the sales management part 17 determines whether the sales management table has recorded the visitor ID. When the sales management table has not recorded the visitor ID although the sales management part 17 has obtained the product-acquire-action information from the processed-subject identification part 15, the sales management part 17 may record the visitor ID on the sales management table and may also record a product ID of a product taken by a visitor's hand on the sales management table in association with the visitor ID. When the sales management table has stored the visitor ID while the sales management part 17 has obtained the product-acquire-action information from the processed-subject identification part 15, the sales management part 17 may record the product ID of the product taken by a visitor's hand on the sales management table in association with the visitor ID. Upon obtaining the product-acquire-action information from the processed-subject identification part 15, the sales management part 17 increments a purchase quantity, which is recorded in association with the product ID of the product taken by a visitor's hand, by one. To firstly record a product ID of a specific product on the visitor table in association with the visitor ID, the sales management part 17 set a purchase quantity of the product taken by a visitor's hand to one. Accordingly, it is possible to record on the sales management table the sales management information including at least the visitor ID, the product ID, and the purchase quantity. In this connection, the product ID and the purchase quantity included in the sales management information may contribute to a visitor's shopping list.

The sales management part 17 determines a necessity as to whether or not to update the sales management information based on the action information obtained from the processed-subject identification part 15 (S204). Upon obtaining the product-return-action information from the processed-subject identification part 15, the sales management part 17 determines it necessary to update the sales management information, thus subtracting one from the purchase quantity relating to the product ID recorded on the sales management table. When the purchase quantity “1” relating to the product ID is recorded on the sales management table in association with the visitor ID, the sales management part 17 will delete the product ID from the sales management table. Accordingly, the sales management part 17 is able to update the sales management information recorded on the sales management table (S205).

A visitor may move around the store 20 while selecting and putting desired products into a cart (or a product basket). After a completion of putting desired products into a cart, the visitor may move to a POS terminal fixed at a register counter in the store 20 or move to the entry/exit gate 2. The store management device 1 is configured to settle the payment of purchased products in cooperation with the POS terminal and the entry/exit camera 24. For example, the POS terminal is equipped with a camera configured to capture a visitor's face. The POS terminal may obtain the product information and the purchase quantity of purchased products by way of an optical reading device or an RFID (Radio Frequency Identification) antenna, thus transmitting to the store management device 1 a settlement request including the product information, the purchase quantity, and a visitor's facial image. The store management device 1 receives the settlement request (S206). The processed-subject identification part 15 determines the visitor ID for setting the payment of purchased products based on a feature quantity of a visitor's facial image and its corresponding feature quantity of facial images recorded on the visitor table. The settlement management part 18 will settle the payment of purchased products when the product information and the purchase quantity, which are recorded on the visitor table in association with the visitor ID for settling the payment of purchased products, match the product information and the purchase quantity obtained from the POS terminal. When setting the payment of purchased products, the settlement management part 18 may retrieve the credit card number which is recorded on the database 40 in association with the visitor ID, thus transmitting the credit card number and the total amount of money to a settlement server (S207). Upon receiving a notice representative of a completion of settlement from the settlement server, the settlement management part 18 determines a completion of settlement for the payment of visitor's purchased products.

The store management device 1 may settle the payment of purchased products according to the following procedure. For example, the entry/exit camera 24 captures a visitor's facial image so as to send the visitor's facial image to the store management device 1. The processed-subject identification part 15 determines a visitor ID for settling the payment of purchased products based on a feature quantity of the visitor's facial image and its corresponding feature quantity of a visitor's facial image recorded on the visitor table. The settlement management part 18 calculates the total amount of money based on the quantity of purchased products and the product information recorded on the visitor table in association with the visitor ID. Thereafter, similar to the above, it is possible to settle the payment of purchased products via the settlement server.

After a completion of settling the payment of purchased products, the settlement management part 18 sends to the visitor table management part 16 and the sales management part 17 a delete request for deleting records, which includes the visitor ID completing the payment of purchased products. Upon receiving the deletion request, the visitor table management part 16 delete the information associated with the visitor ID included in the deletion request from the visitor table (S208). Upon receiving the deletion request, the sales management part 17 deletes the sales management information, which is associated with the visitor ID included in the deletion request, from the sales management table.

As described above, the store management device 1 is configured to delete the information, relating to the visitor who may complete settling the payment of purchased products, from the visitor table and the sales management table. As described above, by deleting the information of the visitor who may complete settlement, it is possible to reduce an amount of information recorded on the visitor table and the sales management table. In addition, it is possible to reduce a load of retrieval processes due to a reduction of a retrieval count of visitors using the visitor table and a reduction of a retrieval count of sales management items using the sales management table.

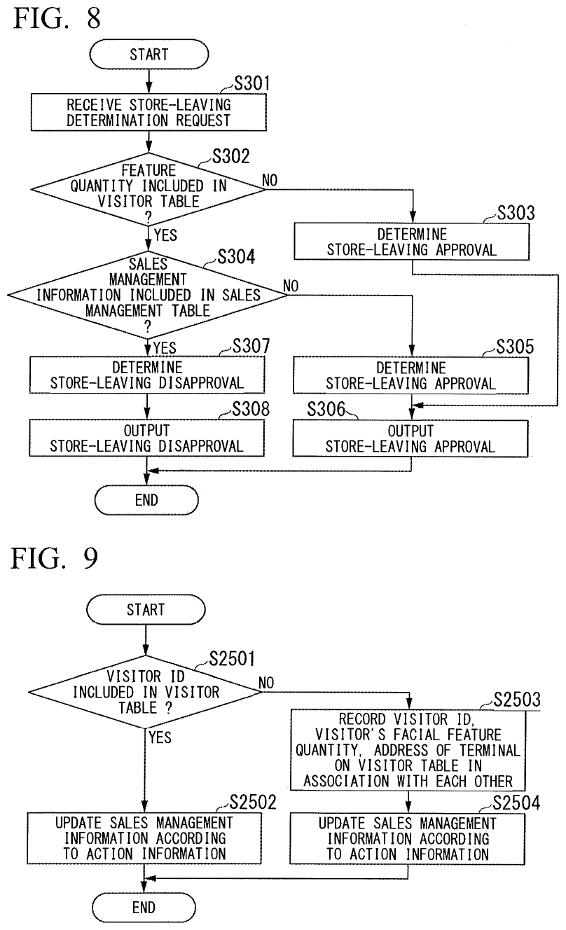

FIG. 8 is a flowchart of a second store management process (steps S301 through S308). As described above, when a visitor leaves the store 20 through the entry/exit gate 2 after completion of settling the payment of purchased products, the entry/exit camera 24 may capture a visitor's facial image so as to transmit a store-leaving determination request including the visitor's facial image to the store management device 1. When the store management device receives the store-leaving determination request (S301), the store-leaving approval part 19 inquires the visitor table management part 16 about whether the visitor table has recorded a feature quantity of the facial image. The visitor table management part 16 determines whether or not the visitor table has included the feature quantity of the facial image relating to the store-leaving determination request (S302). When the visitor table has included the feature quantity of the facial image, the visitor table management part 16 sends to the store-leaving approval part 19 its determination result indicating the existence of the feature quantity which may include the visitor ID identified by the feature quantity. When the visitor table has not included the feature quantity of the facial image, the visitor table management part 16 sends to the store-leaving approval part 19 its determination result indicating the nonexistence of the feature quantity. According to the determination result indicating the nonexistence of the feature quantity, the store-leaving approval part 19 determines that a visitor has completed in settling the payment of purchased products, thus giving the visitor an approval to leave the store 20 (S303).

When the visitor table management part 16 produces the determination result indicating the nonexistence of the feature quantity, due to a remaining possibility that a visitor has not completed in settling the payment of purchased products, the store-leaving approval part 19 reads the visitor ID from the determination result so as to ask the sales management part 17 about whether the sales management table has recorded the sales management information associated with the visitor ID. The sales management part 17 determines whether or not the sales management table has included the sales management information associated with the visitor ID (S304). The sales management part 17 sends to the store-leaving approval part 19 its determination result indicating the existence/nonexistence of the sales management information on the sales management table. When the determination result indicates the nonexistence of the sales management information, the store-leaving approval part 19 determines that a visitor has completed in settling the payment of purchased products, thus giving the visitor an approval to leave the store 20 (S305). Thus, the entry/exit gate 2 of the store 20 will be opened.

When the determination result of the sales management part 17 indicates the existence of the sales management information, the store-leaving approval part 19 determines that a visitor has not completed in settling the payment of purchased products, thus giving the visitor a disapproval of leaving the store 20 (S307). In this case, the store-leaving approval part 19 transmits a store-leaving disapproval to the entry/exit gate 2 and the gate device 23 located in proximity to the entry/exit gate 2 (S308). According to the store-leaving disapproval, an operation to open the entry/exit gate 2 will be stopped. In addition, the gate device 23 may display the screen information urging the visitor to confirm whether or not to complete settling the payment of purchased products on a monitor. Accordingly, it is possible to prevent any visitor who has not completed in settling the payment of purchased products from unduly leaving outside of the store 20. In addition, the store management device 1 may urge the visitor to confirm whether or not to complete settlement.

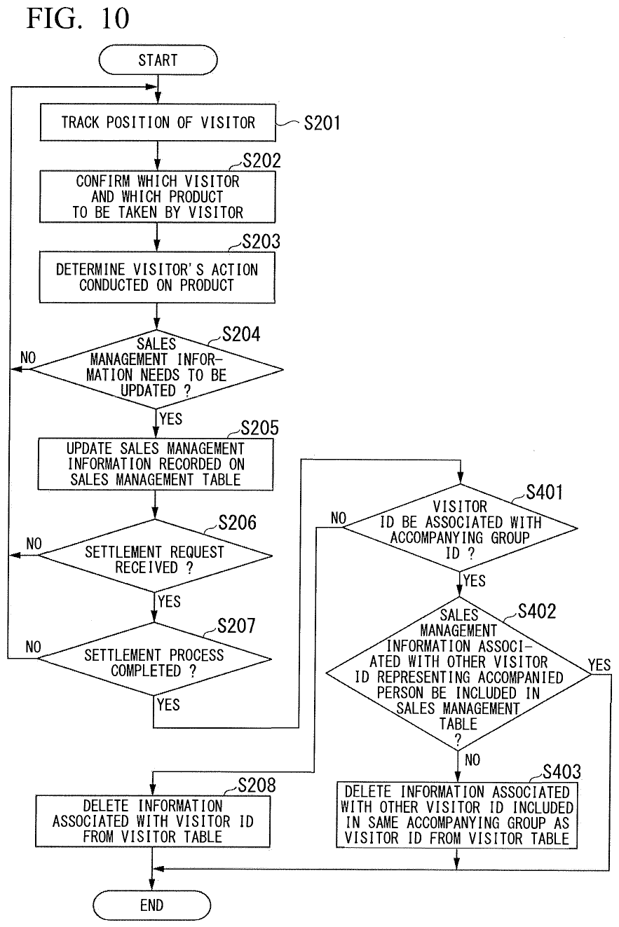

FIG. 9 is a flowchart of a third store management process (steps S2501 through S2504). Irrespective of a completion of settling the payment of purchased product, a visitor may purchase some products displayed on the product shelf 21 again so as to settle payment of those products in the store 20. In this case, the visitor's information has been deleted from the visitor table due to a first-time settlement; hence, it is necessary to add to the visitor information again to the visitor table. This process will be described below.

After step S205 of the first store management process shown in FIG. 7 in which the sales management part 17 started updating the sales management information, the sales management part 17 may inquire the visitor table management part 16 about whether the visitor table has included the visitor ID obtained from the processed-subject identification part 15. The visitor table management part 16 determines whether or not the visitor table has included the visitor ID (S2501). The visitor table management part 16 sends to the sales management part 17 its determination result indicating the existence/nonexistence of the visitor ID on the visitor table. When the determination result indicates the existence of the visitor ID on the visitor table, the sales management part 17 may update the sales management information based on the action information obtained from the processed-subject identification part 15 (S2502). When the determination result indicates the nonexistence of the visitor ID on the visitor table, the sales management part 17 records the visitor ID, a feature quantity of a visitor's facial image which is recorded on the database 40 in association with the visitor ID, and the address of the terminal 7 held by the visitor on the visitor table in association with each other (S2503). Thereafter, the sales management part 17 may update the sales management information based on the action information obtained from the processed-subject identification part 15 (S2504).

As described above, it is possible to record the information of the visitor who may settle the payment of purchased products again on the visitor table. Thereafter, the visitor may settle the payment of purchased products again using the visitor ID included in the visitor table.

FIG. 10 is a flowchart of a fourth store management process (steps S201 through S208, S401 through S403). Considering the existence of another visitor accompanying a visitor who may enter into the store 20, it is assumed that a group including those visitors (hereinafter, referred to as a visitor group) may settle their payment of purchased products once. In this case, after settlement, it is preferable to collectively delete the information relating to all the visitors included in the visitor group from the visitor table. This process will be described below.

Similar to FIG. 7, FIG. 10 includes steps S201 through S208; hence, their descriptions will be appropriately omitted here. When executing a series of steps S201 through S206, the visitor table management part 16 acquires three-dimensional coordinates of a visitor in the store-space domain from the action detection part 14. The visitor table management part 16 compare distances based on three-dimensional coordinates of visitors accompanied together in a predetermined period, which is counted from a predetermined time before the current time, with respect to visitor IDs, thus determining a group of visitor IDs indicating multiple visitors who may be estimated to accompany each other. For example, when a plurality of distances based on three-dimensional coordinates of multiple visitors may be a predetermined ratio or more in a predetermined period, the visitor table management part 16 determine that those visitors may accompany each other, thus assigning a same accompanying group ID (i.e. an ID for a same visitor group). The visitor table management part 16 may record the same accompanying group ID on the visitor table in association with multiple visitor IDs indicating visitors who are determined to accompany each other when entering into the store 20. When a family enters into the store 20, for example, a plurality of visitors constituting the family will be collectively identified as a single group.

Visitors may select desired products from the product shelf 21 and then put into a cart (or a product basket) while moving around the store 20. After completely putting desired products into a cart, visitors may move to the entry/exit gate 2 or a POS terminal installed at a register counter. The settlement management part 18 determines whether to finish settlement of visitors' purchased products (S207). After finishing settlement, the settlement management part 18 sends a deletion request including visitor IDs for finishing settlement to the visitor table management part 16 and the sales management part 17.

Upon receiving the deletion request, the visitor table management part 16 determines whether or not a visitor ID recorded on the visitor table is associated with an accompanying group ID (S401). When the visitor ID is associated with the accompanying group ID on the visitor table, the visitor table management part 16 determines that the visitor having the visitor ID may have an accompanied person. In this case, the visitor table management part 16 retrieves from the visitor table another visitor ID associated with the accompanying group ID. Another visitor ID is an ID of another visitor who may accompany the visitor subjected to settlement of purchased products. The visitor table management part 16 inquires the sales management part 17 about whether the sales management table records the sales management information associated with another visitor ID indicating an accompanied person accompanying the visitor subjected to settlement. The sales management part 17 determines whether or not the sales management table records the sales management information associated with another visitor ID (S402).

The sales management part 17 sends to the visitor table management part 16 its determination results indicting the existence/nonexistence of sales management information with respect to all the visitor IDs associated with the same accompanying group. When the determination result indicates the nonexistence of the sales management information, the visitor table management part 16 deletes from the visitor table the information associated with the visitor ID included in the deletion request received from the settlement management part 18 and another visitor ID included in the same accompanying group as the visitor ID (S403). When the determination result indicates the existence of the sales management information, the visitor table management part 16 may exit the process relating to the deletion request without deleting any visitor IDs from the visitor table. Upon determining that the visitor ID is not associated with the accompanying group ID in step S401, the visitor table management part 16 delete the information associated with the visitor ID from the visitor table (S208).

According to the aforementioned process, it is possible to collectively delete the information of all the visitors included in the accompanying group from the visitor table when any accompanied persons may accompany the visitor subjected to settlement of purchased products. Thus, it is possible to reduce a retrieval count of other visitors included in the accompanying group on the visitor table, and therefore it is possible to reduce a load of retrieval executed by the store management device 1. In this connection, even when it is determined that the sales management table includes the sales management information associated with another visitor ID indicating an accompanied person in step S402, it is unnecessary to delete the sales management information relating to another visitor ID included in the accompanying group. In this case, it is determined that the sales management table includes the sales management information in step S304 shown in FIG. 8 when another visitor may leave the store 20, and therefore the store-leaving approval part 19 may indicate a store-leaving disapproval of another visitor.

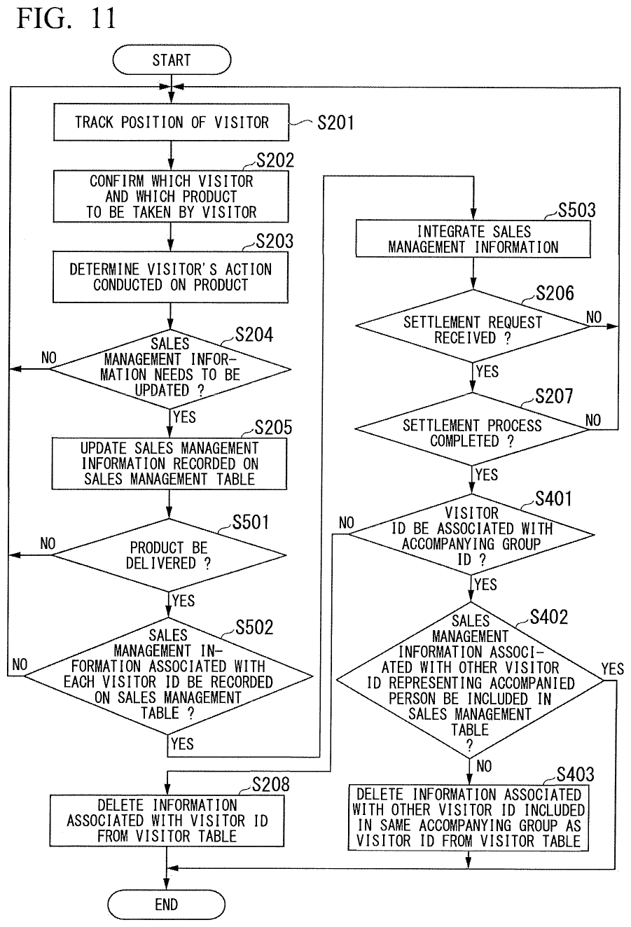

FIG. 11 is a flowchart of a fifth store management process (steps S201 through S208, S401 through S403, S501 through S503). It is assumed that after taking a product from the product shelf 21 by hand, a visitor may likely transfer the product to another visitor serving as an accompanied person. In this case, it is necessary for the store management device 1 to appropriately make a settlement on the visitor who actually purchased products. This procedure will be described below.

FIG. 11 includes steps S201 through S208, S401 through S403 shown in FIG. 10; hence, their descriptions will be appropriately omitted here. In FIG. 11, the action detection part 14 tracks a visitor moving in the store 20 (S201). The action detection part 14 confirm which visitor and which product to be taken by the visitor (S202). Thereafter, a series of steps S203 through S205 shown in FIG. 7 will be executed, and then the action detection part 14 determines whether or not the visitor may transfer the product once taken by hand to another visitor (S501).

For the sake of convenience, the first position information indicates the position of the visitor's biological feature information, the second position information indicates the position of a distal end of a visitor's hand, the third position information indicates the position of the biological feature information of another visitor (or an accompanied person), and the fourth position information indicates the position of a distal end of another visitor's hand. In the step S501, it is determined whether a distance between prescribed entities may fall within a predetermined distance used to recognize whether the second position information representing three-dimensional coordinates of a distal end of a visitor's hand, the product position information representing three-dimensional coordinates of a product, and the fourth position information representing three-dimensional coordinates of a distal end of another visitor's hand (or an accompanied person's hand) may approach each other. Upon determining that the distal-end position of a visitor's hand approaches the distal-end position of another visitor's hand (i.e. the determination result “YES” in step S501), the action detection part 14 may determine whether the product is moved in position when a distance between the product position information representing three-dimensional coordinates of the product and the fourth position information representing three-dimensional coordinates of a distal end of another visitor's hand falls within the predetermined distance used to recognize a grasp of the product. The action detection part 14 determines that the product is transferred from the visitor to another visitor when the product is moved in position under the condition that the distance between the product position information and the fourth position information falls within the predetermined distance used to recognize a grasp of the product.

The action detection part 14 transmits to the processed-subject identification part 15 the action information indicating that the product is transferred from the visitor to another visitor (or an accompanied person). The action information includes the first position information representing the position of a visitor's face, the second position information representing the distal-end position of a visitor's hand, the product position information representing the position of a product, the third position information representing the position of another visitor's face, the fourth position information representing the distal-end position of another visitor's hand, and an identifier indicating that the product is transferred from the visitor to another visitor. Upon obtaining the action information, the processed-subject identification part 15 extracts a feature quantity of another visitor's face and a feature quantity of a visitor's face, which are detected when the product is transferred from the visitor to another visitor, from captured images based on the first position information and the third position information. The processed-subject identification part 15 may determine two visitor IDs on the visitor table based on a facial feature quantity of a visitor and a facial feature quantity of another visitor. The processed-subject identification part 15 sends to the sales management part 17 the transfer information including two visitor IDs representing a visitor and another visitor who may transfer the product therebetween.

Upon receiving the transfer information, the sales management part 17 reads two visitor IDs included in the transfer information. The sales management part 17 determines whether the sales management table records two type of sales management information associated with two visitor IDs (S502). For the sake of convenience, the first sales management information is associated with the visitor ID serving as a transfer source of a product while the second sales management information is associated with another visitor ID serving as a transfer destination of the product. When the sales management table includes two types of sales management information in association with two visitor IDs, the sales management part 17 determines to integrate the first sales management information and the second sales management information. For example, the sales management part 17 determines a visitor ID relating to the position of another visitor's face (i.e. the third position information) correlated to the fourth position information representing the transfer destination of a product so as to integrate the second sales management information associated with the visitor ID with the first sales management information associated with a visitor ID serving as a transfer source of the product (S503). When the same accompanying group ID is assigned to a plurality of visitor IDs, the sales management part 17 integrates the sales management information associated with another visitor ID belonging to the accompanying group ID with the sales management information having the largest quantity of purchased products among multiple types of sales management information associated with visitor IDs belonging to the accompanying group ID.

Subsequently, when the store management device 1 receives a settlement request (S206), the store management device 1 will carry out the procedure (i.e. step S207, S401 through S403, S208) following step S207 as similar to the fourth store management process shown in FIG. 10. In this case, another visitor (or an accompanied person) may accompany a visitor, and therefore in step S403 the visitor table management part 16 deletes from the visitor table the information associated with a visitor ID included in the deletion request received from the settlement management part 18 and another visitor ID included in the same accompanying group.

As described above, even when a product is transferred from one visitor to another visitor, it is possible to recognize those visitors who may pass and receive the product therebetween as accompanied persons, and therefore it is possible to manage single sales management information with multiple accompanied persons. Thus, it is possible to settle the payment of purchased products without any leakage.

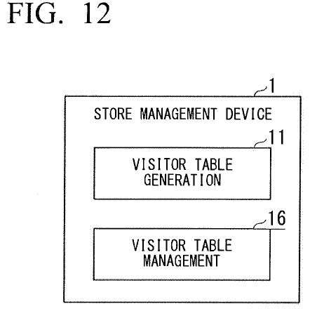

FIG. 12 is a block diagram showing a basic configuration of the store management device 1 according to one embodiment of the present invention. The store management device 1 includes at least the visitor table generation part 11 and the visitor table management part 16. The visitor table generation part 11 is configured to store the information of a visitor who may visit the store 20 and to generate a visitor table used for making a store-leaving approval. The visitor table management part 16 is configured to delete the information of a visitor from the visitor table at a completion of settling the payment of products purchased by the visitor.

The store management device 1 includes a computer system therein, wherein the foregoing processes are stored as computer programs on computer-readable storage media, and therefore a computer may read and execute computer programs to achieve the foregoing processes shown in FIG. 5 through FIG. 11. Herein, computer-readable storage media refers to magnetic disks, magneto-optical disks, CD-ROM, DVD-ROM, semiconductor memory and the like. In addition, it is possible to deliver computer programs to a computer through communication lines, and therefore the computer may execute computer programs.

The aforementioned computer programs may achieve part of functions of the store management device 1. Alternatively, the aforementioned computer programs may be differential programs (or differential files) which can be combined with pre-installed programs already recorded on the computer system so as to achieve the functionality of the store management device 1.

Lastly, the present invention is not necessarily limited to the foregoing embodiment, and therefore the present invention may embrace various modifications and design changes falling within the scope of the invention as defined in the appended claims.

The present application claims the benefit of priority on Japanese Patent Application No. 2018-53215 filed on Mar. 20, 2018, the subject matter of which is hereby incorporated herein by reference.

### INDUSTRIAL APPLICABILITY

The present invention is configured to automatically store on a visitor table the information of visitors who may visit stores for use in settlement of payment of purchased products, management of stores, and determination of store-leaving approval but the present invention is not necessarily limited to a field of managing stores. The present invention can be applied to other management fields upon observing users' actions in public facilities such as railroad stations and airports.

### REFERENCE SIGNS LIST

1 store management device
2 entry/exit gate
3 first camera
4 motion sensor
5 second camera
6 product detection sensor
7 terminal
10 control part
11 visitor table generation part
12 first position information acquisition part
13 second position information acquisition part
14 action detection part
15 processed-subject identification part
16 visitor table management part
17 sales management part
18 settlement management part
19 store-leaving approval part
20 store
21 product shelf
23 gate device
24 entry/exit camera
40 database

1. A store management device comprising:
a visitor table generation part configured to generate a visitor table used to record information of a visitor who visits a store; and
a visitor table management part configured to delete the information of the visitor who leaves the store from the visitor table after a predetermined process.

2. The store management device according to claim 1, further comprising a sales management part configured to generate a sales management table used to record sales management information including the visitor and product information of a product held by the visitor.

3. The store management device according to claim 2, further comprising a store-leaving approval part configured to make a store-leaving approval of the visitor when the information of the visitor is deleted from the visitor table.

4. The store management device according to claim 2, wherein the predetermined process is a settlement of products purchased by the visitor, and wherein the store-leaving approval part makes the store-leaving approval of the visitor when the sales management table records unsettled product information.

5. The store management device according to claim 2, further comprising a settlement management part configured to make a settlement request when the visitor table records the information of the visitor while the sales management table records the unsettled product information.

6. The store management device according to claim 2, wherein the visitor table management part is configured to record the information of the visitor on the visitor table due to nonexistence of the information of the visitor on the visitor table when recording the product information of the product held by the visitor on the sales management table.

7. The store management device according to claim 2, wherein upon determining a plurality of visitors belonging to a same accompanying group, the visitor table management part is configured to record information of the plurality of visitors on the visitor table in association with each other.

8. The store management device according to claim 7, wherein the predetermined process is a settlement of products purchased by the visitor, and wherein after completion of settlement, the information of the visitor is deleted from the visitor table while information of another visitor belonging to the same accompanying group as the visitor is deleted from the visitor table.

9. The store management device according to claim 7, further comprising an action detection part configured to determine whether the product held by the visitor is transferred to the other visitor belonging to the same accompanying group, wherein the sales management part is configured to integrate and record the sales management information of the visitor and sales management information of the other visitor on the sales management table.

10. A store management method comprising:
generating a visitor table used to record information of a visitor who visits a store; and
deleting the information of the visitor who leaves the store from the visitor table after a predetermined process.
